(19) United States
(12) Patent Application Publication
(10) Pub. No.: US 2023/0066981 A1
(43) Pub. Date: Mar. 2, 2023

(54) Pipe Joint Locking Tool

(71) Applicant: ECOOL CO., LTD., Gyeonggi-do (KR)

(72) Inventor: Jeonhan Lee, Gyeonggi-do (KR)

(21) Appl. No.: 17/759,972

(22) PCT Filed: Mar. 13, 2020
(86) PCT No.: PCT/KR2020/003491

§ 371 Date: Aug. 2, 2022

(30) Foreign Application Priority Data
Feb. 3, 2020 (KR) 20-2020-0000408

(51) Int. Cl. B25B 27/14

(52) U.S. Cl. CPC B25B 27/14

(57) ABSTRACT

The present invention relates to a pipe joint locking tool. According to one example of the present invention, provided is a pipe joint locking tool which fixes and couples a pipe joint including a connection member and a tightening member to a conduit, the pipe joint locking tool being characterized by comprising: a first lever and a second lever, which rotate about a lever hinge shaft; and a pair of tightening chucks coupled to the upper ends of the first and second levers, the pair of tightening chucks being provided with pipe joint supporting portions on which the connection member and the tightening member are respectively placed and supported, and tightening and coupling the pipe joint to the conduit by moving the tightening member toward the connection member according to the operation of the first and second levers, wherein the pair of tightening chucks having the pipe joint supporting portions of a size matching the size of the pipe joint are selected from a group having pipe joint supporting portions of different sizes, and are coupled to the upper ends of the first and second levers so as to be replaceable.

### TECHNICAL FIELD

The present invention relates to a pipe joint locking tool, and more particularly, to a pipe joint locking tool for easily fixing and coupling pipe joints having various sizes and including a connection member and a tightening member to a conduit.

### BACKGROUND ART

In general, a conduit is a passage through which a fluid flows. The conduit is used in various equipment or system fields using fluids. Upon installing the conduit, pipe joints are used for various reasons such as structural or spatial characteristics. The pipe joints or pipe connectors serve to connect conduits to each other.

Korean Unexamined Patent Publication No. 10-2007-0079597 discloses a conduit fastener of a conduit connector according to one conventional example.

There are various ways to connect conduits using a pipe joint or a pipe connector. Various schemes are used such as a screw connection scheme, and a flange joint or swaging scheme. Among these, a method of fastening a pipe joint or a pipe connectors by using the swaging scheme, which is simple and ensuring airtightness, has been spotlighted. For example, a method of connecting pipes by the swaging scheme, as a method of connecting pipes effective for frequent movements or replacements of air conditioning equipment in the air conditioning field, is attracting attention.

The method of connecting pipes by the swaging scheme refers to a method, in which a fastening member is moved toward a center by using a general tool to tighten a pipe joint or a pipe connector, thereby tightening pipes. At this point, the tool is required to be suitably used for the size of the pipe joint or pipe connector. Because the size of the conduit or pipe joint varies it is inefficient and uneconomical to prepare tools by size.

Accordingly, there is a need for a swaging tool readily available for various sizes of pipe joints, pipe connectors, or conduits.

### DISCLOSURE

### Technical Problem

The present invention provides a pipe joint locking tool having a replaceable tightening chuck to easily fix and couple pipe joints having various sizes and including a connection member and a tightening member to a conduit.

### Technical Solution

To solve the above-described problem, proposed is a pipe joint locking tool according to one aspect of the present invention which fixes and couples a pipe joint including a connection member and a tightening member to a conduit, which includes: a first lever and a second lever, which rotate about a lever hinge shaft; and a pair of tightening chucks coupled to upper ends of the first and second levers, each provided with pipe joint supporting portions on which the connection member and the tightening member are respectively placed and supported, and tightening and coupling the pipe joint to the conduit by moving the tightening member toward the connection member according to the operation of the first and second levers, wherein the pair of tightening chucks having supporting portions of a size matching the size of the pipe joint and selected from a group having pipe joint supporting portions of different sizes are coupled to the upper ends of the first and second levers so as to be replaceable.

In one example, each of the first and second levers may be formed to allow the tightening chuck to be inserted into an inner empty space from the upper end portion or pulled out from the inner empty space while the first and second levers are hinged and coupled, each of the first and second levers may include a first chuck support portion formed on an upper side of a hinge shaft coupling portion, and each of the tightening chucks may further include a lever fastening groove seated and fastened to the first chuck support portion, a coupling support hole, and a coupling support member inserted into the coupling support hole to support the coupling state with each lever of the tightening chuck so as to be maintained when the lever of the pipe joint locking tool is operated.

In one example, the first chuck support portion may have a pin structure, the lever fastening groove may have a structure in which the first chuck support portion is seated while passing theretrough, the coupling support hole may be formed in any one of both side walls forming the lever fastening groove when viewed in a sectional view, the coupling support member may include a support body elastically supported and having a part protruding from the coupling support hole to an inside of the lever fastening groove to support the first chuck support portion, and the support body may be elastically retracted when the tightening chucks are fastened to the first and second levers, and separated from the first and second levers, respectively, to allow the first chuck support portion to be seated in the lever fastening groove, and the first chuck support portion to be separated from the lever fastening groove.

In addition, in one example, the coupling support member further may include a housing formed therein with an inner groove and formed on an outer side thereof with a thread, an elastic body installed in the inner groove to support a ball body serving as the support body, and a tool groove formed on a rear end surface of the housing, and the coupling support member may be screwed into the coupling support hole by inserting and rotating a tool in the tool groove.

In addition, in one example, the first chuck support portion may have a pin structure, the 1 ever fastening groove may have a structure in which the first chuck support portion is seated while passing theretrough, the coupling support hole may be formed in both side walls forming the lever fastening groove when viewed in a sectional view, the coupling support member may be a support pin that traverses the lever fastening groove so as to be fastened to the coupling support holes of the both side walls, thereby supporting the first chuck support portion, the support pin may be seated and then installed in the lever fastening groove of the first chuck support portion when the tightening chucks are inserted to the first and second levers, respectively, and the tightening chucks may be separated from the first and second levers, respectively, by separating the first chuck support portion from the lever fastening groove after the separation of the support pin. The support pin is configured to include a pin body inserted into the coupling support hole and formed in one side thereof with a head fastening groove, a pin head having a protruding insertion protrusion fastened to the head fastening groove of the pin body, and a magnet ring sandwiched between the pin body and the pin head and having a through-hole into which the insertion protrusion and one side of the pin body are inserted, and the tightening chuck may be formed of a ferromagnetic material having strong adhesion with respect to the magnet ring.

In another example, the pin body is formed at one side thereof a head fastening groove therein and includes a ring fastening portion having an outer diameter smaller than an outer diameter of a body of the pin body and fitted into the through-hole, the insertion protrusion of the pin head is fastened to the head fastening groove of the ring fastening portion passing through the through-hole, and the ring fastening portion has a tapered part connected to the body of the pin body, in which an outer diameter of a distal end may be formed smaller than the outer diameter of the body of the pin body, and the through-hole may have inner diameters different at both ends so as to match the tapered part of the ring fastening portion and the distal end of the ring fastening portion formed with the outer diameter smaller than the body of the pin body.

In addition, in one example, the tightening chuck further includes a body portion formed with an inner wall and an outer wall longer than the inner wall and having an upper end connected to the inner wall to form to define the lever fastening groove, the coupling support hole is form ed in one or both of the inner wall and the outer wall, the pipe joint support portion has a two-step groove structure integrally protruding from an upper side of the body portion, a stepped wall of the two-step groove structure supports protruding side surfaces of the connection member and the tightening member, each of the first and second levers further includes a second chuck support portion that supports the outer wall of the tightening chuck under the hinge shaft coupling portion and prevents the tightening chuck from rotating or shaking when the pipe joint is fastened to the conduit by the pipe joint locking tool, the first and second chuck support portions have a pin structure, and each of the tightening chucks is configured such that the first chuck support portion of any one of the first and second levers is seated and fastened to the lever fastening groove, and rotating or shaking is prevented by the remaining second chuck support portion.

In another example, the pipe joint locking tool further includes: a ratchet member provide d as a set at lower end parts of the first and second levers, so as to be operated in a direction in which the lower ends of the first and second levers gather to each other; and handle portions formed at lower ends of the first and second levers, respectively, for lever operation, wherein the ratchet member includes a fixing portion formed at a lower end of any one of the first and second levers, a ratchet gear portion formed on a lower end of a remaining one of the first and second levers so as to be rotated, and a chain portion having one end coupled to the fixing portion and an opposite end coupled to the ratchet gear portion, and one of the handle portions may be a ratchet operation handle provided at the lower end of the lever installed with a ratchet gear portion so as to be hinged and rotated for operations of the ratchet member.

In one example, the ratchet operation handle includes a ratchet latching piece elastically supported and caught in some of a plurality of latching grooves formed in the ratchet gear portion to enable ratchet rotation according to the hinge rotation for ratchet operation of the ratchet operation handle, the ratchet member may further include a ratchet releasing member provided at a low er end of the lever around the ratchet gear portion to release a latching state of the ratchet latching piece when the ratchet operation handle is pulled outward, thereby enabling the ratchet gear portion to rotate in a reverse direction.

In addition, in one example, a spring may be provided inside the ratchet operation handle, and an opposite end of the chain portion exceeding a part fastened to the ratchet gear portion may be coupled to the spring.

In another example, a remaining one of the handle portions is an angle adjustment handle provided at a lower end of the lever formed with the fixing portion, and hinged and fixed so as to adjust an angle, the fixing portion is formed with a plurality of angle adjustment latching grooves for adjusting the angle of the angle adjustment handle, and the angle adjustment handle may include a fixing latching piece elastically supported and caught in any one of the angle adjustment latching grooves to fix a rotational state of the angle adjustment handle, and an operation handle protruding on the fixing latching piece to release a latching state of the fixing latching piece.

### Advantageous Effects

The pipe joint locking tool having a replaceable tightening chuck according to one embodiment of the present invention can easily fix and couple pipe joints having various sizes and including a connection member and a tightening member to a conduit.

Even though some effects are not directly mentioned in the specification of the present invention, it is apparent that various characteristic effects may be derived within the understanding of those of ordinary skill in the art from the features of the configuration or various configurations included in various embodiments and modifications of the present invention.

### DESCRIPTION OF DRAWINGS

FIG. 1 is a view schematically showing a state of a pipe joint locking tool before operation according to one embodiment of the present invention.

FIG. 2 is a view schematically showing a state of the pipe joint locking tool in operation according to one embodiment of the present invention.

FIG. 3a is a view schematically showing a state of the pipe joint locking tool in operation according to one embodiment of the present invention.

FIG. 3b is a view schematically showing a state of the pipe joint locking tool in operation according to one embodiment of the present invention.

FIG. 3c is an enlarged view of a connection part between a lever and a handle portion of FIG. 3b.

Each of FIGS. 4a and 4b is a view schematically showing a tightening chuck of the pipe joint locking tool according to one embodiment of the present invention.

FIG. 5 is a view schematically showing a pipe joint locking tool according to another embodiment of the present invention.

FIG. 6 is a view schematically showing a latching release state by a ratchet release member in the pipe joint locking tool according to FIG. 5.

FIG. 7 is a view schematically showing an example of a tightening chuck used for the pipe joint locking tool according to FIG. 5.

FIG. 8 is a view schematically showing a disassembled state of a support pin used in FIG. 7.

FIG. 9 is a view schematically showing a fastening section of a pipe joint fastened by using the pipe joint locking tool according to one embodiment of the present invention.

### BEST MODE

According to one embodiment of the present invention, a pipe joint locking tool for coupling and fixing a pipe joint 1 including a connection member 1a and a tightening member 1b to a conduit 5 includes: a first lever 10a and a second lever 10b rotating about a lever hinge shaft 11; and a pair of tightening chucks 30 coupled to upper ends of the first and second levers 10a and 10b, each provided with pipe joint supporting portions 31 on which the connection member 1a and the tightening member 1b are respectively placed and supported, and tightening and coupling the pipe joint 1 to the conduit by moving the tightening member 1b toward the connection member 1a according to the operation of the first and second levers 10a and 10b, wherein the pair of tightening chucks 30 having supporting portions of a size matching the size of the pipe joint 1 and selected from a group having pipe joint supporting portions 31 of different sizes are coupled to the upper ends of the first and second levers 10a and 10b so as to be replaceable.

### Mode for Invention

Embodiments of the present invention for achieving the above object will be described with reference to the accompanying drawings. In the following description, the same reference numeral refers to the same component, and the secondary description may be omitted in order to facilitate the understanding of the present invention to those of ordinary skill in the art.

In the present specification, when one component forms a coupling relationship such as connection or coupling in a relationship with other component, unless there is a limitation of ‘directly’, another component may be related therebetween and exist in the form of a coupling relationship via a medium in addition to the ‘direct’ coupling relationship. In addition, the terms indicating directions such as ‘front’ and ‘rear’ will be interpreted as relative concepts with respect to a reference element.

In this specification, it will be noted that even one component expressed in the singular may be used as a concept representing the entirety of a plurality of components, unless interpreted contrary to or contradictory to the concept of the invention.

In addition, in this specification, the description of expressions such as ‘including’ and ‘comprising’ and terms derived therefrom do not exclude the possibility of addition, combination or coupling of one or more other elements to the original element or elements. Further, the description of expression having the meaning of ‘having’, ‘being composed of’, and the like and terms derived therefrom do not exclude the possibility of adding or combining the one or more other elements, unless the original elements or elements lose their characteristics, functions and/or properties by addition, combination or coupling of one or more other elements to the original element or elements.

The drawings referred in the present specification are examples for explaining embodiments of the present invention, and the shape, size, thickness and the like may be exaggerated or reduced for effective description of technical features. In addition, in the drawings for describing the embodiments of the present invention, some of the configurations of the embodiments may be omitted or expressed only by description in order to help the overall understanding of the invention or the understanding of the rest of the configurations.

A pipe joint locking tool according to one aspect of the present invention will be described in detail with reference to the drawings. Reference numerals not shown in the referred drawings may correspond to reference numerals in other drawings indicating the same configuration. The configurations disclosed in each figure may be partially omitted or modified to be implemented according to variations of the embodiment, and it will be noted that even an essential configuration of the invention in each drawing may be omitted and described to help understanding of other configurations.

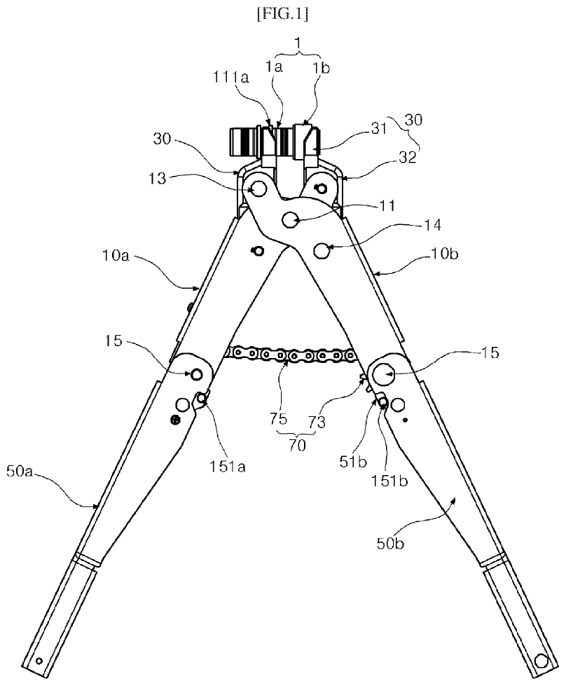

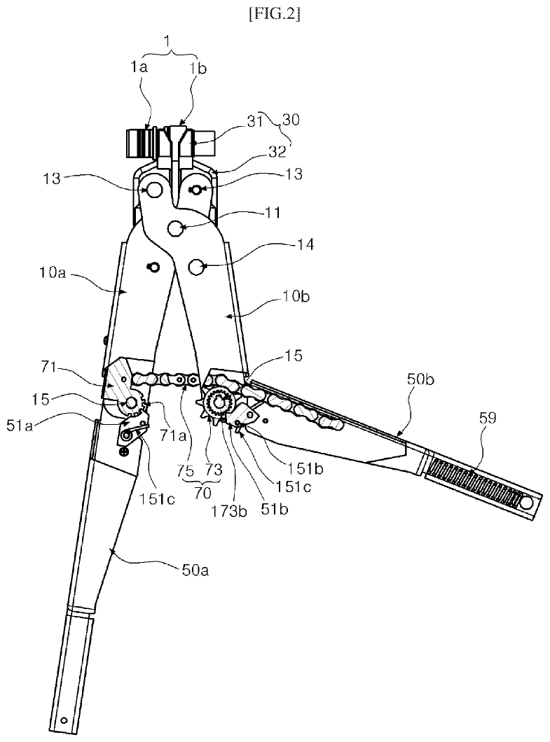

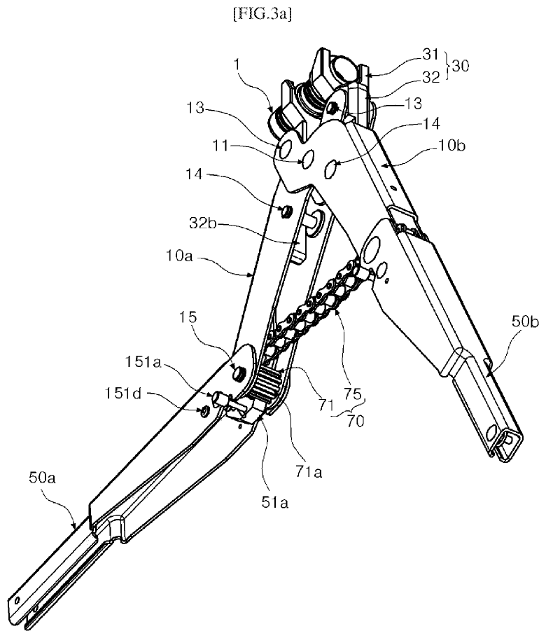

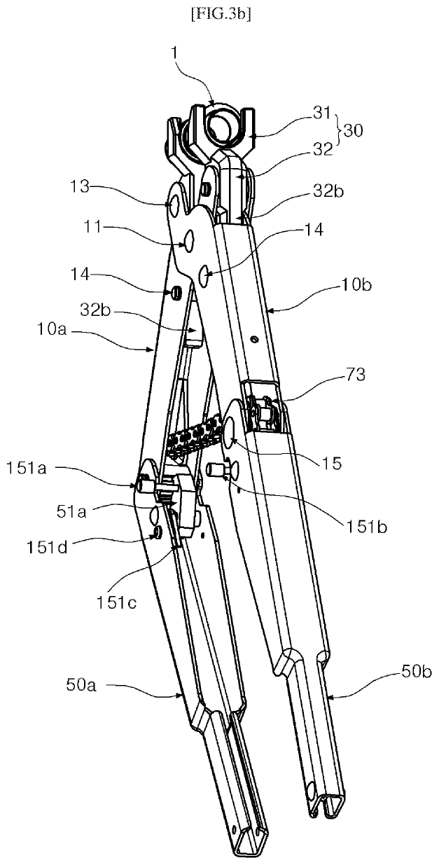

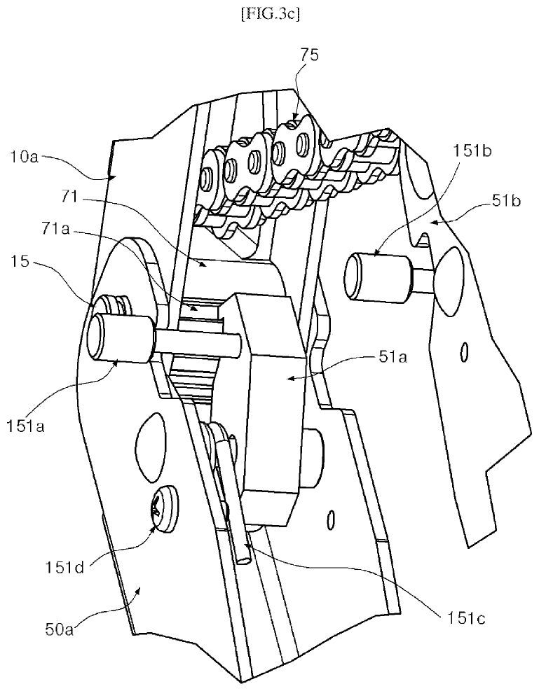

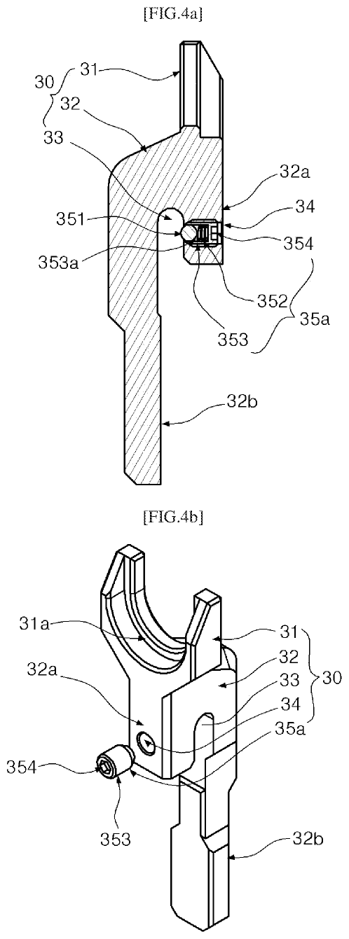

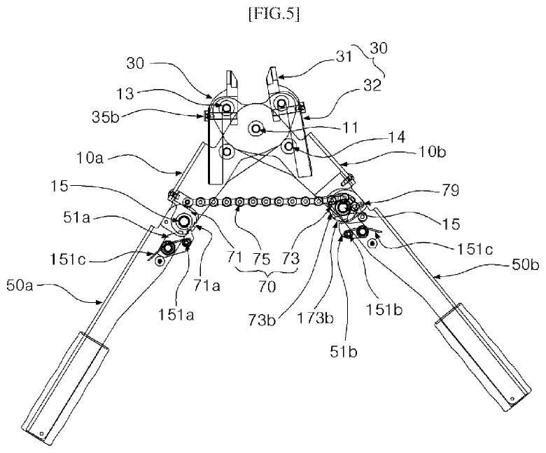

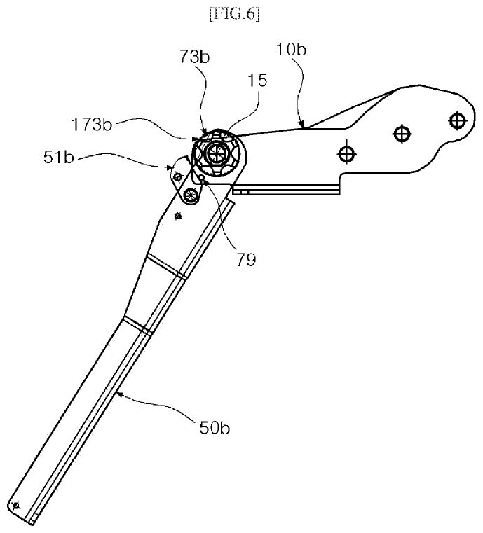

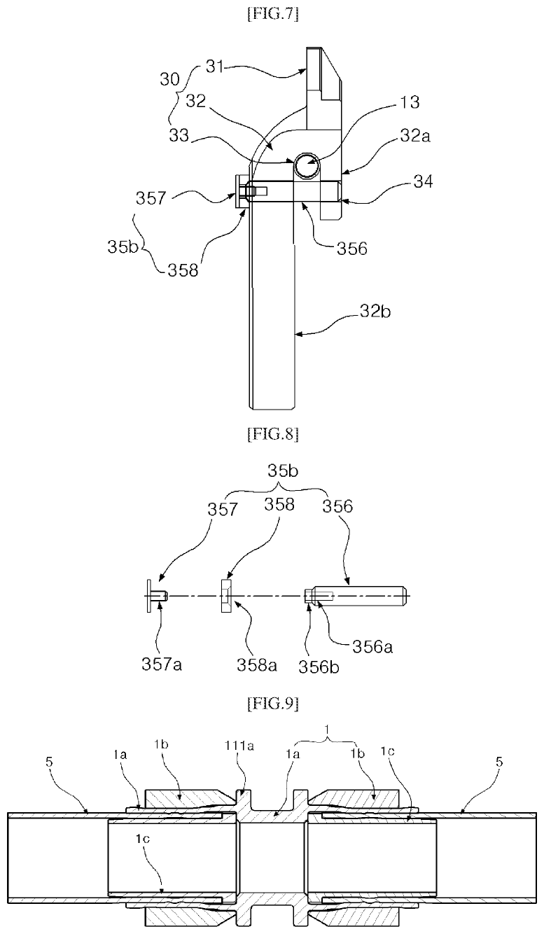

FIG. 1 is a view schematically showing a state of a pipe joint locking tool before operation according to one embodiment of the present invention. FIG. 2 is a view schematically showing a state of the pipe joint locking tool in operation according to one embodiment of the present invention. FIG. 3a is a view schematically showing a state of the pipe joint locking tool in operation according to one embodiment of the present invention. FIG. 3b is a view schematically showing a state of the pipe joint locking tool in operation according to one embodiment of the present invention. FIG. 3c is an enlarged view of a connection part between a lever and a handle portion of FIG. 3b. FIG. 4a is a sectional view schematically showing a tightening chuck of the pipe joint locking tool according to one embodiment of the present invention. FIG. 4b is a perspective view schematically showing a tightening chuck of the pipe joint locking tool according to one embodiment of the present invention. FIG. 5 is a view schematically showing a pipe joint locking tool according to another embodiment of the present invention. For the reference, in order to understand the present invention, FIG. 5 explicitly shows, unlike in FIGS. 1 to 3b, parts of the tightening chuck 30 and the ratchet member 70 to be covered by the first and second levers 10a and 10b and the handle portions 50a and 50b. FIG. 6 is a view schematically showing a latching release state by a ratchet release member in the pipe joint locking tool according to FIG. 5. FIG. 7 is a view schematically showing an example of a tightening chuck used for the pipe joint locking tool according to the example of FIG. 5. FIG. 8 a view schematically showing a disassembled state of a support pin used in FIG. 7. In addition, FIG. 9 a view schematically showing a fastening section of a pipe joint fastened by using the pipe joint locking tool according to one embodiment of the present invention.

Referring to FIGS. 1 to 3b and 5, the pipe joint locking tool according to one embodiment is a tool for coupling and fixing a pipe joint 1 including a connection member 1a and a tightening member 1b to a conduit (see reference numeral 5 in FIG. 9). The pipe joint locking tool includes a first lever 10a, a second lever 10b, and a tightening chuck 30. For example, referring to FIGS. 1 to 3b and 5, in another example, the pipe joint locking tool may further include handle portions 50a and 50b and a ratchet member 70.

First, a pipe joint 1 fixedly coupled to a conduit 5 by the pipe joint locking tool according to one example of the present invention will be described in brief with reference to FIG. 9. The pipe joint 1 shown in FIG. 9 is illustrated as an example for further understanding of the present invention, and the scope of the present invention will not be construed as being limited thereto. Referring to FIG. 9, the pipe joint 1 includes a connection member 1a and a tightening member 1b. One end of the conduit 5 is inserted into the connection member 1a and the tightening member 1b is pulled toward a center of the connection member 1a, so that the connection member 1a may be tightened by the tightening member 1b, thereby being airtight-coupled to an outside of the conduit 5. Two conduits 5 are inserted and connected from both sides of the connection member la and the tightening member 1b is pulled from the both sides toward the center, so that the two conduits 5 may be connected to each other. For example, the pipe joint 1 may further include an inner support pipe member 1c in order to protect the conduit 5 from being dented inward and improve the tightening connection. The inner support pipe member 1c is inserted into the conduit 5 and then the conduit 5 is inserted into the connection member 1a and tightened by the tightening member 1b, so that the conduit 5 may be connected. For example, the connection member 1a may be provided with a support protrusion 356ba having a protruding side wall supported by the tightening chuck 30 of the pipe joint locking tool according to one example of the present invention, and the tightening member 1b may have a structure same as or similar to a nut or ring shape and have sections of both ends supported by the tightening chuck 30. In addition, for example, the tightening member 1b may be formed to have an inner diameter having a rear smaller than a front (in the direction of the center of the connection member), so as to be tightened with the pipe 5 by tightening the connection member 1a according to the tightening using the pipe joint locking tool according to one example of the present invention.

Hereinafter, the embodiment of the present invention will be described. The first and second levers 10a and 10b rotate about the lever hinge shaft 11. A pair of tightening chucks 30 are provided to be coupled to upper ends of the first and second levers 10a and 10b, respectively. Each of the tightening chucks 30 is provided with a pipe joint support portion 31 for seating and supporting any one of the connection member 1a and the tightening member 1b. The tightening chuck 30 moves the tightening member 1b toward the connection member 1a according to the operation of the first and second levers 10a and 10b and tightens the pipe joint 1 to the conduit 5. The pair of tightening chucks 30 having supporting portions of a size matching the size of the pipe joint 1 and selected from a group having pipe joint supporting portions 31 of different sizes are coupled to the upper end of the first and second levers 10a and 10b so as to be replaceable.

Hereinafter, each configuration will be described in more detail with reference to FIGS. 1 to 7. The first and second levers 10a and 10b and the pair of tightening chucks 30 will be described first and then the ratchet member 70 and the handle portions 50a and 50b will be described.

First and Second Levers 10a and 10b

Referring to FIGS. 1 to 3b and 5, the first lever 10a and the second lever 10b rotate about the lever hinge shaft 11. The structure of the first and second levers 10a and 10b rotating about the lever hinge shaft 11 is a structure applied to general tools, such as pliers. In the example of the present invention, the shape and structure are different from those of the general tools in that the pair of tightening chucks 30 are coupled to the upper ends of the first and second levers 10a and 10b.

For example, each of the first and second levers 10a and 10b may be formed to allow the tightening chuck 30 to be inserted into an inner empty space from the upper end portion or pulled out from the inner empty space while the first and second levers 10a and 10b are hinged and coupled.

For example, in one example, each of the first and second levers 10a and 10b includes a first chuck support portion 13. The first chuck supporting portion 13 is formed above the hinge shaft-coupling portion, that is, the coupling portion of the lever hinge shaft 11 in each of the levers 10a and 10b. The first chuck supporting portion 13 may have various shapes or structures. Referring to FIGS. 1 to 3b and 5, the first chuck supporting portion 13 may have a pin structure. The lever fastening groove 33 may have a structure in which the first chuck support portion 13 having a pin structure is seated while passing theretrough. Although not shown in the drawings, the first chuck supporting portion 13 may have a plate-shaped protruding structure fastened to the lever fastening groove 33 of the tightening chuck 30 described later, however, the present invention is not limited thereto. The first chuck supporting portion 13 is a structure fastened to the lever fastening groove 33 of the tightening chuck 30 to support the tightening chuck 30, and may be variously modified.

In addition, referring to FIGS. 1 to 3b and 5, in one example, each of the first and second levers 10a and 10b may further include a second chuck supporting portion 14. The second chuck supporting portion 14 may be formed below the hinge shaft-coupling portion, that is, the coupling portion of the lever hinge shaft 11 in each of the levers 10a and 10b so as to support an outer wall 32b of the tightening chuck 30 and prevent the tightening chuck 30 from rotating or shaking when the pipe joint 1 is fastened to the conduit 5 by the pipe joint locking tool. For example, referring to FIGS. 1 to 3b and 5, the second chuck support portion 14 also may have a pin structure. In another embodiment, the second chuck supporting portion 14 may have various shapes or structures other than the pin structure.

For example, each of the first and second levers 10a and 10b may have a hollow therein and be formed with an opening to or from which the tightening chuck 30 is inserted or withdrawn at the upper end, and the first and/or second chuck support portions 13 and 14 may be formed in a pin structure. The first and/or second chuck support portions 13 and 14 may be replaceable.

For example, referring to FIGS. 1 to 3b and 5, at least one of the first and second levers 10a and 10b may have a handle portion hinge shaft 15 at a lower end thereof. The handle portion hinge shaft 15 allows the handle portions 50a and 50b coupled to the lower end of the levers 10a and 10b to be rotatable. Referring to FIGS. 1 to 3b and 5, the handle portion hinge shafts 15 are provided to both of the first and second levers 10a and 10b, however, may be provided to only one thereof unlike shown in the drawings.

Tightening Chuck 30

Referring to FIGS. 1 to 3b and 5, a pair of tightening chucks 30 are provided to be coupled to upper ends of the first and second levers 10a and 10b, respectively. Hereinafter, it is noted that the tightening chuck 30 may be used as a term denoting all of a pair or each of the pair. The tightening chuck 30 moves the tightening member 1b toward the connection member 1a according to the operation of the first and second levers 10a and 10b and tightens the pipe joint 1 to the conduit 5. Each of the tightening chucks 30 has a pipe joint support portion 31. The pipe joint support portion 31 seats and supports the connection member 1a or the tightening member 1b.

One of the pair of tightening chucks 30 may seat the connection member 1a on the pipe joint support portion 31, the remaining one may seat the tightening member 1b on the pipe joint support portion 31, and the connection member and the tightening member may be pushed in a direction facing each other, so that the pipe joint 1 may be tightened and coupled to the conduit 5. For example, when the connection member 1a and the tightening member 1b are pushed in the direction facing each other using the pair of tightening chucks 30, the fastening member 1b advances along an outer circumferential surface of the connection member 1a to tighten the connection member 1a, and the tightened connection member 1a tightens the conduit 5 inserted therein, so that the pipe joint 1 may be tightened and coupled to the conduit 5.

The pair of tightening chucks 30 having supporting portions of a size matching the size of the pipe joint 1 and selected from a group having pipe joint supporting portions 31 of different sizes are coupled to the upper end of the first and second levers 10a and 10b so as to be replaceable. In other words, in one example of the present invention, the tightening chuck 30 is replaceable, and the pipe joint support portion 31 may have a size varied for each tightening chuck 30. Thus, the tightening chuck 30 having a pipe joint support portion 31 of a size matching between pipe joints 1 to be connected may be replaced and installed on the upper end of the first and second levers 10a and 10b, so as to easily perform a connection work for pipe joints 1 having various sizes.

For example, referring to FIGS. 1 to 5 and 7, each of the tightening chucks 30 may further include a coupling support hole 34 and coupling support members 35a and 35b. FIG. 4a shows a state in which the coupling support member 35a is inserted into the coupling support hole 34 according to one example. FIG. 4b shows a state before the coupling support member 35a is inserted into the coupling support hole 34 according to one example. FIG. 7 shows a state in which the coupling support member 35b is inserted into the coupling support hole 34 according to another example. In FIG. 7, the part where the coupling support member 35b is inserted into the coupling support hole 34 of the tightening chuck 30 is shown explicitly without being covered. The coupling support hole 34 refers to a hole into which the coupling support members 35a and 35b are inserted. The coupling support members 35a and 35b are inserted into the coupling support hole 34, and support the coupling state with each lever 10a and 10b of the tightening chuck 30 so as to be maintained when the lever of the pipe joint locking tool is operated. For example, the coupling support members 35a and 35b may have a long pin shape or a short pin shape, however, the present invention is not limited thereto.

For example, referring to FIGS. 4a to 4b, the coupling support member 35a may perform elastic supporting. For example, when the coupling support member 35a performs the elastic supporting, the tightening chuck 30 may be configured to be easily separated from each of the levers 10a and 10b or easily coupled to each of the levers 10a and 10b. For example, the coupling support member 35a hay have a part protruding from the coupling support hole 34 to an inside of the lever fastening groove 33 to support the first chuck support portion 13 of the lever. For example, when the first chuck support portion 13 has a pin structure, the coupling support member 35a may support between a side surface and a lower side of the pin structure. Alternatively, although not shown in the drawings, for example, when the first chuck support portion 13 has a protruding plate shape, the coupling support member 35a may come into close contact with a groove formed in the plate shape to and support the plate shape. However, the present invention is not limited thereto. The coupling support member 35a shown in FIGS. 4a to 4b will be described in more detail later.

For example, referring to FIGS. 5, 7 and 8, the coupling support member 35b may be a support pin 35b. The support pin 35b may traverse the lever fastening groove 33 so as to be fastened to the coupling support holes 34 of the walls on both sides, thereby supporting the first chuck support portion 13. The first chuck supporting portion 13 may have a pin structure. The coupling support member 35b shown in FIGS. 7 to 8 will be described in more detail later.

For example, referring to FIGS. 1 to 5 and 7, in one example, each of the tightening chucks 30 may further include a lever fastening groove 33. The lever fastening groove 33 may be seated and fastened to the first chuck support portion 13 of the levers 10a and 10b. For example, the lever fastening groove 33 may have a structure in which the first chuck support portion 13 having a pin structure is seated while passing theretrough. Alternatively, although not shown in the drawings, when the first chuck support portion 13 has a protruding plate-shaped structure, the lever fastening groove may be a groove in which the protruding plate-shaped structure of the first chuck support portion substantially matches on the side plate of the tightening chuck 30.

For example, the coupling support hole 34 may be formed in one or both side walls defining the lever fastening groove 33 in a sectional view. For example, referring to FIGS. 4a to 4b, the coupling support hole 34 may be formed in an inner wall defining the lever fastening groove 33 in a sectional view, that is, in a wall in a direction of the pair of tightening chucks 30 facing each other. However, the present invention is not limited thereto. For example, referring to FIGS. 5, 7 and 8, the coupling support hole 34 may be formed in both side walls defining the lever fastening groove 33 in a sectional view.

The coupling support members 35a and 35b will be described in more detail with reference to FIGS. 4a, 4b, 7 and 8. First, one example of the coupling support member 35a will be described with reference to FIGS. 4a to 4b.

For example, referring to FIG. 4a, the coupling support member 35a may include a support body 351. The support body 351 is elastically supported and has a part protruding from the coupling support hole 34 to the inside of the lever fastening groove 33 to support the first chuck support portion 13. For example, when the tightening chucks 30 are fastened to the first and second levers 10a and 10b, and separated from the first and second levers 10a and 10b, respectively, the support body 351 may be elastically retracted to allow the first chuck support portion 13 to be seated in the lever fastening groove 33 and the first chuck support portion 13 to be separated from the lever fastening groove 33. For example, the support body 351 may be a ball body 351, however, the present invention is not limited thereto. For example, the support body 351 may be a hemisphere or a shape formed by combining a hemisphere with a cylinder.

In addition, referring to FIGS. 4a to 4b, in one example, the coupling support member 35a may further include a housing 353 and an elastic body 352. The housing 353 of the coupling support member 35a is formed therein with an inner groove 353a. For example, a thread may be formed on an outer side of the housing 353. The outer thread may be screw-coupled to a thread formed on an inner circumferential surface of the coupling support hole 34. For example, the inner groove 353a of the housing 353 may have a shape smaller toward an inlet. Accordingly, the support body 351, for example, the ball body 351 may be prevented from being separated from the inner groove 353a to the outside. The elastic body 352 of the coupling support member 35a is installed in the inner groove 353a to support the support body 351, for example, the ball body 351. For example, a spring 352 inserted into the inner groove 353a may support the ball body 351. A different elastic material other than the spring may be used. Preferably, the spring may be used to facilitate elastically supporting and enable the tightening chuck 30 to be easily replaceable.

Referring to FIGS. 4a to 4b, in another example, the coupling support member 35a may further include a tool groove 354. The tool groove 354 is formed on a rear end surface of the housing 353. The coupling support member 35a may be screwed into the coupling support hole 34 by inserting and rotating the tool in the tool groove 354.

Next, another example of the coupling support member 35b will be described with reference to FIGS. 7 to 8. For example, referring to FIGS. 7 to 8, the support pin 35b may include a pin body 356, a pin head 357 and a magnet ring 358. Referring to FIG. 8, a fastening groove 356a is formed on one side of the pin body 356. Referring to FIG. 8, the pin head 357 has a protruding insertion protrusion 357a fastened to the fastening groove 356a of the pin body 356. Referring to FIG. 8, the magnet ring 358 is sandwiched between the pin body 356 and the pin head 357 and includes a through-hole 358a into which one sides of the insertion protrusion 357a and the pin body 356 are inserted. The tightening chuck 30 provided with the lever fastening groove 33 into which the support pin 35b is inserted may be formed of a ferromagnetic material having strong adhesion with respect to the magnet ring 358.

For example, referring to FIG. 8, the one side of the pin body 356 is provided with a ring fastening portion 356b. The ring fastening portion 356b is formed therein with a fastening groove 356a, and has an outer diameter smaller than that of a body of the pin body 356, so as to be inserted into the through-hole 358a. The insertion protrusion 357a of the pin head 357 may be fastened to the inner fastening groove 356a of the ring fastening portion 356b passing through the through-hole 358a of the magnet ring 358.

For example, the ring fastening portion 356b may have a tapered part connected to the body of the pin body 356, in which an outer diameter of a distal end may be formed smaller than the outer diameter of the body of the pin body 356. The through-hole 358a of the magnet ring 358 may have inner diameters different at both ends so as to match the tapered part of the ring fastening portion 356b and the distal end of the ring fastening portion 356b formed with the outer diameter smaller than the body of the pin body 356.

For example, the pin body 356 and/or the pin head 357 of the support pin 35b may be formed of a ferromagnetic material.

For example, referring to FIGS. 1 to 5 and 7, in one example, each of the tightening chucks 30 may further include a body portion 32. The body portion 32 may be formed by connecting upper ends of the inner wall 32a and the outer wall 32b to each other. For example, a coupling support hole 34 may be formed in one or both of the inner wall 32a and the outer wall 32b. For example, referring to FIGS. 4a to 4b, the coupling support hole 34 may be formed in the inner wall 32a, and the lever fastening groove 33 may be defined by the inner wall 32a, the outer wall 32b, and the upper connecting part. In addition, referring to FIG. 7, the coupling support hole 34 may be formed in both of the inner wall 32a and the outer wall 32b, and the lever fastening groove 33 may be defined by the inner wall 32a, the outer wall 32b, and the upper connecting part. Referring to FIGS. 4a, 4b and 7, the lever fastening groove 33 may pass through the body portion 32 region of the tightening chuck 30 and inner wall 32a and the outer wall 32b may be formed on both sides thereof in the drawing. In addition, in the drawing, a lower side of the body portion 32 may be open and an upper side thereof may be formed in a structure in which the inner wall 32a and the outer wall 32b are connected to each other, in which the first chuck support portion 13 having a pin structure may be seated while passing through the lever fastening groove 33. In addition, the outer wall 32b may be longer than the inner wall 32a. For example, the inner wall 32a is a wall in which the pair of tightening chucks 30 face each other. For example, referring to FIGS. 4a to 4b, the coupling support hole 34 formed in the inner wall 32a may be formed to be positioned, for example, at a point on the lower side of the first chuck support portion 13 seated and fastened to the lever fastening groove 33, so that the point on the lower side of the first chuck support portion 13 may be supported by the coupling support member 35a.

For example, referring to FIG. 4b, the pipe joint support portion 31 of the tightening chuck 30 may have a two-step groove structure integrally protruding from the upper side of the body portion 32. The pipe joint support portion 31 of the tightening chuck 30 of FIG. 7 may also have a two-step groove structure as in FIG. 4b. A stepped wall 31a of the two-step groove structure may support protruding side surfaces of the connection member 1a and the tightening member 1b. For example, a side surface of a vertical protrusion formed on the connection member 1a or a side end surface of the nut or ring-shaped tightening member 1b may be supported. For example, two annular protrusions spaced apart from each other may be formed in the middle of a periphery of the connection member 1a, in which the stepped wall 31a of one tightening chuck 30 supports the inner side of one of the two annular protrusions, and the stepped wall 31a of the other tightening chuck 30 supports an outer end surface of the nut or ring-shaped tightening member 1b fastened to the outer side of the annular protrusion of the connection member 1a, so that the pipe joint 1 may be tightened and coupled to the conduit 5 according to the operation of the levers.

For example, referring to FIGS. 1 to 3b and 5, each of the tightening chucks 30 is configured such that the first chuck support portion 13 of any one of the first and second levers 10a and 10b may be seated and fastened to the lever fastening groove 33, and rotation or oscillation may be prevented by the remaining second chuck support portion 14. For example, the first chuck support portion 13 of any one of the first and second levers 10a and 10b may be seated and fastened to the lever fastening groove 33 of each tightening chuck 30, and the outer wall 32b of the tightening chuck 30 upon the tightening operation of the pipe joint locking tool may be supported by the second chuck support 14 of the remaining lever and prevented from being rotated.

Next, the configuration of the ratchet member 70 and the handle portions 50a and 50b according to another example of the present invention will be described in detail.

Ratchet Member 70

Referring to FIGS. 1 to 3b and 5, the pipe joint locking tool according to one example may further include a ratchet member 70. The ratchet member 70 is provided as a set at lower end parts of the first and second levers 10a and 10b, so as to be operated in a direction in which the lower ends of the first and second levers 10a and 10b gather to each other For example, handle portions 50a and 50b formed for lever operation may be provided at the lower end parts of the first and second levers 10a and 10b provided with the ratchet member 70. One of the handle portions 50a and 50b may be a ratchet operation handle 50b provided at the lower end of the lever installed with a ratchet gear portion 73 of the ratchet member 70 so as to be hinged and rotated for the operation of the ratchet member 70.

For example, referring to FIGS. 1 to 3b and 5, the ratchet member 70 may include a fixing portion 71, a ratchet gear portion 73 and a chain portion 75. The fixing portion 71 is formed in the lower end of any one of the first and second levers 10a and 10b. The fixing portion 71 is coupled to one end of the chain portion 75. For example, referring to FIGS. 2 and/or 5, the fixing portion 71 may be coupled to the handle portion hinge shaft 15 formed at the lower end of the lever, and have one side coupled to the body portion 32 of the lever so as not to rotate. For example, in one example, a plurality of angle adjustment latching grooves 71a may be formed in the fixing portion 71. For example, a plurality of angle adjustment latching grooves 71a for adjusting an angle of an angle adjustment handle 50a described later may be formed around a coupling part between the fixing portion 71 and the handle portion hinge shaft 15. A fixing latching piece 51a of the angle adjustment handle 50a is caught in any one of the angle adjustment latching grooves 71a of the fixing portion 71, so as to adjust a rotational angle of the angle adjustment handle 50a.

The ratchet gear portion 73 is installed at the lower end of the remaining one, which is not provided with the fixing portion 71, of the first and second levers 10a and 10b. For example, the ratchet gear portion 73 may be rotatably coupled to the handle portion hinge shaft 15 formed at the lower end of the lever. For example, the ratchet gear portion 73 may rotate and allow the chain portion 75 to move in one direction. At this point, the moving in one direction signifies that the ratchet gear portion 73 is rotated in the one direction by a ratchet latching piece 51b described later, fixed and then prevented from being unwound in the reverse direction by itself.

The chain portion 75 has one end coupled to the fixing portion 71 and an opposite end coupled to the ratchet gear portion 73.

For example, the ratchet gear portion 73 may be provided with a plurality of latching grooves, that is, a plurality of ratchet latching grooves 173b for ratchet operation, in addition to a chain gear to which the chain portion 75 is fastened. For example, the ratchet latching grooves 173b may be formed around a ratchet latching plate 73b formed on one side of the chain gear to which the chain portion 75 is fastened. The ratchet operation handle 50b may be provided with a ratchet latching piece 5 1b caught in a portion of the latching grooves formed in the ratchet gear portion 73, that is, the ratchet latching grooves 173b to enable the ratchet rotation. When a force is applied to move the ratchet operation handle 50b in the ratchet operation direction, for example, in the opposite handle direction (that is, inward direction), the ratchet latching piece 51b may be caught in a portion of the ratchet latching grooves 173b formed in the ratchet gear portion 73, thereby rotating the ratchet gear portion 73 in one direction and preventing the rotation in the reverse direction. When a force is applied to move the ratchet operation handle 50b in the reverse direction of the ratchet, for example, in the outward direction, for example, the ratchet latching piece 51b just previously caught in the ratchet latching groove 173b by the inclination angle of the ratchet latching groove 173b may be retracted along the periphery of the ratchet latching plate 73b, moved to ratchet latching groove 173b rearward and then caught, and the ratchet operation handle 50b may be moved in the ratchet operation direction, for example, in the inward direction to rotate the ratchet gear portion 73.

For example, the ratchet latching piece 5 1b provided on the ratchet operation handle 50b may be a partial configuration of the ratchet member 70.

Referring to FIGS. 5 to 6, in one example, the ratchet member 70 may further include a ratchet release member 79. The ratchet release member 79 may be installed at the lower end of the lever around the ratchet gear portion 73. Referring to FIG. 6, the ratchet release member 79 may release a latching state of the ratchet latching piece 51b when the ratchet operation handle 51b is pulled outward, thereby enabling the ratchet gear portion 73 to rotate in the reverse direction. For example, when the ratchet operation handle 51b rotates outward, the ratchet latching piece 51b rotatably and elastically supported on the ratchet operation handle 51b may be moved, and pushed and rotated by the ratchet release member 79, and the latching state in the ratchet locking groove 173b may be released. When the ratchet operation handle 51b is further pulled outward while the latching state of the ratchet latching piece 51b is released, the ratchet gear portion 73 is reversely rotated to release the chain portion 75, thereby widening a gap between the lower ends of the first and second levers 10a and 10b and a gap between the pair of tightening chucks 30.

For example, referring to FIG. 2, an operation handle 151b may be provided on the ratchet latching piece 51b and the operation handle 151b may be pulled outward to release the latching state of the ratchet latching piece 51b, thereby allowing the reverse rotation of the ratchet gear portion 73.

For example, referring to FIG. 2, the other end of the chain portion 75 exceeding the part fastened to the ratchet gear portion 73 may be coupled to a spring 59 provided inside the ratchet operation handle 51b. FIG. 2 shows the spring 59 provided inside the handle portions 50a and 50b, but omits a state of the other end of the chain portion 75 coupled to the spring.

Handle Portions 50a and 50b

Referring to FIGS. 1 to 3b, 5 and 6, the pipe joint locking tool according to one example may further include handle portions 50a and 50b. The handle portions 50a and 50b are formed at lower ends of the first and second levers 10a and 10b, respectively, for lever operation. Referring to FIGS. 1 to 3b, 5 and 6, in one example, one of the handle portions 50a and 50b may be the ratchet operation handle 50b installed at the lower end of the lever installed with the ratchet gear portion 73 so as to be hinged and rotated for the operation of the ratchet member 70. In addition, referring to FIGS. 1 to 3b and 5, the remaining one of the handle portions 50a and 50b may be the angle adjustment handle 50a rotatably fixed to the lower end of the lever. FIGS. 1 to 3b and 5, the angle adjustment handle 50a may be fixed to adjust the rotation angle around the handle portion hinge shaft 15 provided at the lower end of the lever.

For example, the angle adjustment handle 50a may include a fixing latching piece 51a and an operation handle 151a. For example, the operation handle 151a may be a partial configuration included in the fixing latching piece 51a. For example, a plurality of angle adjustment latching grooves 71a for angle adjustment of the angle adjustment handle 50a may be formed around the coupling part of the handle portion hinge shaft 15 in the area of the fixing portion 71 of the ratchet member 70. A fixing latching piece 51a of the angle adjustment handle 50a is caught in any one of the angle adjustment latching grooves 71a of the fixing portion 71, so that the rotation angle of the angle adjustment handle 50a may be adjusted and the rotational state may be fixed at the same time.

The operation handle 151a may protrude from the fixing latching piece 51a. The operation handle 151a may be manipulated to release the latching state of the fixing latching piece 51a. For example, the angle adjustment handle 50a may be rotated in any one or more directions, either in the direction of the other handle or in the opposite direction.

For example, the ratchet operation handle 50b may include the ratchet latching piece 51b. The ratchet latching piece 51b may be elastically supported on the ratchet operation handle 50b, and caught in some of the latching grooves 173b formed in the ratchet gear portion 73 according to the hinge rotation for ratchet operation of the ratchet operation handle 50b, thereby enabling the ratchet rotation. For example, the ratchet latching piece 51b provided on the ratchet operation handle 50b may be a partial configuration of the ratchet member 70.

For example, referring to FIG. 2, the spring 59 coupled to the chain portion 75 of the ratchet member 70 may be provided in the inner space of the ratchet operation handle 50b. Although not shown in the drawings, in FIG. 5 as in FIG. 2, the spring 59 may be provided in the inner space of the ratchet operation handle 50b.

For example, referring to FIGS. 2 and/or 5, the fixing latching piece 51a of the angle adjustment handle 50a, and/or the ratchet latching piece 51b of the ratchet operation handle 50b may be provided with a torsion spring 151c for elastically supporting the fixing latching piece 51a and/or the ratchet latching piece 51b. The torsion spring 151c may be installed on a rotating shaft the same as the fixing latching piece 51a and/or the ratchet latching piece 51b, in which one end may be fixed to the rotating shaft or supported by a separate support piece 151d formed on the fixing latching piece 51a and/or the ratchet latching piece 51b shown in FIG. 2, and the other end may support the operation handle 151a on the fixing latching piece 51a and/or the operation handle 151b on the ratchet latching piece 51b. Accordingly, the fixing latching piece 51a and/or the ratchet latching piece 51b may be rotated while being elastically supported by the torsion spring 151c. The elastic support of the torsion spring 151c may maintain the latching state in which the fixing latching piece 51a and/or the ratchet latching piece 5 1b is latched to the angle adjustment latching groove 71a and/or the ratchet latching groove 173b.

The above-described embodiments and the accompanying drawings do not limit the scope of the present invention and have been exemplarily described to help those of ordinary skill in the art for the present invention to understand. Various modifications may be obviously implemented according to various combinations of the above-described components by those of ordinary skill in the art. In other words, the various embodiments of the present invention may be implemented in variously modified forms according to various combinations of the above-described components without departing from the essential features of the present invention. Accordingly, the scope of the present invention will be construed according to the invention described in the claims, and the present invention includes various modifications, alternatives, and equivalent embodiments by those skilled in the art in addition to the above-described embodiments.

### INDUSTRIAL APPLICABILITY

The present invention relates to a pipe joint locking tool, and may be usefully used industrially in the field of piping equipment.

1. A pipe joint locking tool for fixing and coupling a pipe joint including a connection member and a tightening member to a conduit, the pipe joint locking tool comprising:
a first lever and a second lever which rotate about a lever hinge shaft; and
a pair of tightening chucks coupled to upper ends of the first and second levers, and each including pipe joint supporting portions on which the connection member and the tightening member are respectively placed and supported, to tighten and couple the pipe joint to the conduit by moving the tightening member toward the connection member depending upon operations of the first and second levers, wherein
the pair of tightening chucks having supporting portions of a size matching a size of the pipe joint and selected from a group having pipe joint supporting portions of different sizes are coupled to the upper ends of the first and second levers so as to be replaceable.

2. The pipe joint locking tool of claim 1, wherein each of the first and second levers is formed to allow the tightening chuck to be inserted into an inner empty space from the upper end portion or pulled out from the inner empty space while the first and second levers are hinged and coupled,
each of the first and second levers includes a first chuck support portion formed on an upper side of a hinge shaft coupling portion, and
each of the tightening chucks further includes a lever fastening groove seated and fastened to the first chuck support portion, a coupling support hole, and a coupling support member inserted into the coupling support hole to support the coupling state with each lever of the tightening chuck so as to be maintained when the lever of the pipe joint locking tool is operated.

3. The pipe joint locking tool of claim 2, wherein the first chuck support portion has a pin structure,
the lever fastening groove has a structure in which the first chuck support portion is seated while passing therethrough,
the coupling support hole is formed in any one of both side walls forming the lever fastening groove when viewed in a sectional view,
the coupling support member includes a support body elastically supported and having a part protruding from the coupling support hole to an inside of the lever fastening groove to support the first chuck support portion, and
the support body is elastically retracted when the tightening chucks are fastened to the first and second levers, and separated from the first and second levers, respectively, to allow the first chuck support portion to be seated in the lever fastening groove and the first chuck support portion to be separated from the lever fastening groove.

4. The pipe joint locking tool of claim 3, wherein the coupling support member further includes a housing formed therein with an inner groove and formed on an outer side thereof with a thread, an elastic body installed in the inner groove to support a ball body serving as the support body, and a tool groove formed on a rear end surface of the housing, and wherein
the coupling support member is screwed into the coupling support hole by inserting and rotating a tool in the tool groove.

5. The pipe joint locking tool of claim 2, wherein the first chuck support portion has a pin structure,
the lever fastening groove has a structure in which the first chuck support portion is seated while passing theretrough,
the coupling support hole is formed in both side walls forming the lever fastening groove when viewed in a sectional view,
the coupling support member is a support pin that traverses the lever fastening groove so as to be fastened to the coupling support holes of the opposite side walls, thereby supporting the first chuck support portion,
the support pin is seated and then installed in the lever fastening groove of the first chuck support portion when the tightening chucks are inserted to the first and second levers, respectively,
the tightening chucks are separated from the first and second levers, respectively, by separating the first chuck support portion from the lever fastening groove after the separation of the support pin,
the support pin is configured to include a pin body inserted into the coupling support hole and formed in one side thereof with a head fastening groove, a pin head having a protruding insertion protrusion fastened to the head fastening groove of the pin body, and a magnet ring sandwiched between the pin body and the pin head and having a through-hole into which the insertion protrusion and one side of the pin body are inserted, and
the tightening chuck is formed of a ferromagnetic material having strong adhesion with respect to the magnet ring.

6. The pipe joint locking tool of claim 5, wherein the pin body is formed at one side thereof a head fastening groove therein and includes a ring fastening portion having an outer diameter smaller than an outer diameter of a body of the pin body and fitted into the through-hole,
the insertion protrusion of the pin head is fastened to the head fastening groove of the ring fastening portion passing through the through-hole,
the ring fastening portion has a tapered part connected to the body of the pin body, in which an outer diameter of a distal end is formed smaller than the outer diameter of the body of the pin body, and
the through-hole has opposite ends having different inner diameters so as to match the tapered part of the ring fastening portion and the distal end of the ring fastening portion formed with the outer diameter smaller than the body of the pin body.

7. The pipe joint locking tool of claim 2, wherein the tightening chuck further includes a body portion formed with an inner wall and an outer wall longer than the inner wall and having an upper end connected to the inner wall to form to define the lever fastening groove,
the coupling support hole is formed in one or both of the inner wall and the outer wall,
the pipe joint support portion has a two-step groove structure integrally protruding from an upper side of the body portion,
a stepped wall of the two-step groove structure supports protruding side surfaces of the connection member and the tightening member,
each of the first and second levers further includes a second chuck support portion that supports the outer wall of the tightening chuck under the hinge shaft coupling portion and prevents the tightening chuck from rotating or shaking when the pipe joint is fastened to the conduit by the pipe joint locking tool,
the first and second chuck support portions have a pin structure, and
each of the tightening chucks is configured such that the first chuck support portion of any one of the first and second levers is seated and fastened to the lever fastening groove, and rotating or shaking is prevented by the remaining second chuck support portion.

8. The pipe joint locking tool of claim 1, further comprising:
a ratchet member provided as a set at lower end parts of the first and second levers so as to be operated in a direction in which the lower ends of the first and second levers gather to each other; and
handle portions formed at lower ends of the first and second levers, respectively, for lever operation, wherein
the ratchet member includes a fixing portion formed at a lower end of any one of the first and second levers, a ratchet gear portion formed on a lower end of a remaining one of the first and second levers so as to be rotated, and a chain portion having one end coupled to the fixing portion and an opposite end coupled to the ratchet gear portion, and
one of the handle portions includes a ratchet operation handle provided at the lower end of the lever installed with a ratchet gear portion so as to be hinged and rotated for operations of the ratchet member.

9. The pipe joint locking tool of claim 8, wherein the ratchet operation handle includes a ratchet latching piece elastically supported and caught in some of a plurality of latching grooves formed in the ratchet gear portion to enable ratchet rotation according to the hinge rotation for ratchet operation of the ratchet operation handle, and
the ratchet member further includes a ratchet releasing member provided at a lower end of the lever around the ratchet gear portion to release a latching state of the ratchet latching piece when the ratchet operation handle is pulled outward, thereby enabling the ratchet gear portion to rotate in a reverse direction.

10. The pipe joint locking tool of claim 8, wherein a spring is provided inside the ratchet operation handle, and
an opposite end of the chain portion exceeding a part fastened to the ratchet gear portion is coupled to the spring.

11. The pipe joint locking tool of claim 8, wherein a remaining one of the handle portions includes an angle adjustment handle provided at a lower end of the lever formed with the fixing portion and hinged and fixed so as to adjust an angle,
the fixing portion is formed with a plurality of angle adjustment latching grooves for adjusting the angle of the angle adjustment handle, and
the angle adjustment handle includes a fixing latching piece elastically supported and caught in any one of the angle adjustment latching grooves to fix a rotational state of the angle adjustment handle, and an operation handle protruding on the fixing latching piece to release a latching state of the fixing latching piece.
